(19) United States
(12) Patent Application Publication
(10) Pub. No.: US 2007/0264882 A1
(43) Pub. Date: Nov. 15, 2007

(54) Battery terminal connector and conductive elements thereof

(75) Inventor: Wei-Chun Lin, Chang Hwa (TW)

Correspondence Address: BRUCE H. TROXELL, SUITE 1404, 5205 LEESBURG PIKE, FALLS CHURCH, VA, 22041, US

(73) Assignee: K.S. TERMINALS INC.

(21) Appl. No.: 11/430,836

(22) Filed: May 10, 2006

(51) Int. Cl. H01R 4/28

(52) U.S. Cl. 439/754

(57) ABSTRACT

A battery terminal connector is disclosed. The connector includes an electrically conductive element and an electrically insulating element having a slot for accommodating the electrically conductive element. The electrically conductive element has two apart located terminal connecting parts each of which includes two wavelike fins leading a first direction and one wavelike fin leading a second direction, and the included angle Θ between the first direction and the direction is larger than zero but smaller than 90 degrees. In addition, each wavelike fin is formed with curved portion, and the space between these curved portions of the same terminal connecting part is vertically shorter than the thickness of the battery terminal.

### BACKGROUND OF THE INVENTION

1. Field of the Invention

The present invention is directed to a connector, and more particularly to a battery terminal connector used for connecting two batteries in series.

2. Description of the Related Art

The Uninterruptible Power Supply (UPS), a device provides electrical power for a system, is mainly composed of batteries. These batteries are full charged in usual time and act to avoid unrecoverable damages to the electrical system when the alternating current (AC) power failure or abnormal voltage break is detected. Since the power come from the UPS is important to the system, a need to connect more batteries in series for the UPS becomes unavoidable.

As shown in FIG. 2, the conventional UPS has its terminals 21 formed of bended metal sheets having through holes 213. The already known method to connect two batteries in series is to use a wire having two terminals 7 as shown in FIG. 12 to connect the positive terminal of one battery and the negative terminal of the other battery. However, the terminals 7 as shown in FIG. 12 have problems in connecting with the terminals 21 when terminals 21 are slightly deformed, and the terminals 21 may easily to escape from the terminals 7 for the weak clamping force between the terminals 21 and the wire terminals 7.

In view of this, a battery terminal connector 1 which is compliant with the slight deformation of the battery terminals 21 and firmly buckled with the terminals 21 is presented.

### BRIEF SUMMARY OF THE INVENTION

According to the above mentioned problem considering the serial connection of battery terminals by wire terminals, the present invention provides an improved battery terminal connector which enables user to easily connect two batteries in series even the battery terminals 21 are subjected to slight deformation. Another objective of the invention is to provide a battery terminal connector which is capable of firmly coupling with the battery terminals 21.

The battery terminal connector according to the invention includes an electrically conductive element and an electrically insulating element having a slot for accommodating the electrically conductive element. The electrically conductive element has two apart located terminal connecting parts each of which includes two wavelike fins leading a first direction and one wavelike fin leading a second direction, and the included angle Θ between the first direction and the second direction is larger than zero but smaller than 90 degrees. In addition, each wavelike fin is formed with curved portion, and the space between these curved portions of the same terminal connecting part is vertically shorter than the thickness of the battery terminal.

In one embodiment, the open end of the middle wavelike fin of one terminal connecting part and the open end of the middle wavelike fin of the other terminal connecting part have the same orientation.

In another embodiment, the orientation of the open end of the middle wavelike fin of one terminal connecting part and the orientation of the open end of the middle wavelike fin of the other terminal connecting part open end include an angle which is the same as the included angle Θ between the first direction and the second direction. Besides, the width of the curved portion of the middle wavelike fin is smaller than the width of the curved portion of other wavelike fins for each terminal connecting part, and there is misalignment between the curved portion of the middle wavelike fin and the curved portion of other wavelike fins for each terminal connecting part.

The battery terminal connector according to the present invention is easily to assemble and provides larger claming force when compared with the prior art. Furthermore, the presented battery terminal connector can be applied not only to the UPS but also batteries of other type such as accumulator for motorcycle.

### BRIEF DESCRIPTION OF THE DRAWINGS

FIG. 1 is a schematic view showing that the battery terminal connector according to one embodiment of the invention is connected to the battery terminals for connecting two batteries in series.

FIG. 2 is a schematic view showing the battery terminals of the battery terminal connector in FIG. 1.

FIG. 3 is a perspective view showing the electrically insulating element of the battery terminal connector according to one embodiment of the invention.

FIG. 4 is a front view showing the structure of the electrically insulating element of the battery terminal connector in FIG. 1.

FIG. 5 is a schematic view showing the structure of the electrically conductive element of the battery terminal connector according to one embodiment of the invention.

FIG. 6A is a side view showing the structure of the electrically conductive element of the battery terminal connector according to one embodiment of the invention.

FIG. 6B is a front view showing the structure of the electrically conductive element of the battery terminal connector according to one embodiment of the invention.

FIG. 7 is a side view showing the relationship between the electrically conductive element in FIG. 6A and one battery terminal.

FIG. 8 is a side view showing the connecting relationship between the electrically conductive element in FIG. 6A and one battery terminal.

FIG. 9A is a side view showing the structure of the electrically conductive element of the battery terminal connector according to another embodiment of the invention.

FIG. 9B is a front view showing the structure of the electrically conductive element of the battery terminal connector according to another embodiment of the invention.

FIG. 10 is a side view showing the geometric relationship between the electrically conductive element in FIG. 9A and one battery terminal.

FIG. 11 is a side view showing the connecting relationship between the electrically conductive element in FIG. 9A and one battery terminal.

FIG. 12 is a schematic view showing the prior wire terminal.

FIG. 13 is a perspective view showing the electrically insulating element of the battery terminal connector according to another embodiment of the invention.

FIG. 14A is a front view showing the electrically insulating element in FIG. 13.

FIG. 14B is a top view showing the electrically insulating element in FIG. 13.

FIG. 14C is a side view showing the electrically insulating element in FIG. 13.

### DETAILED DESCRIPTION OF PREFERRED EMBODIMENTS

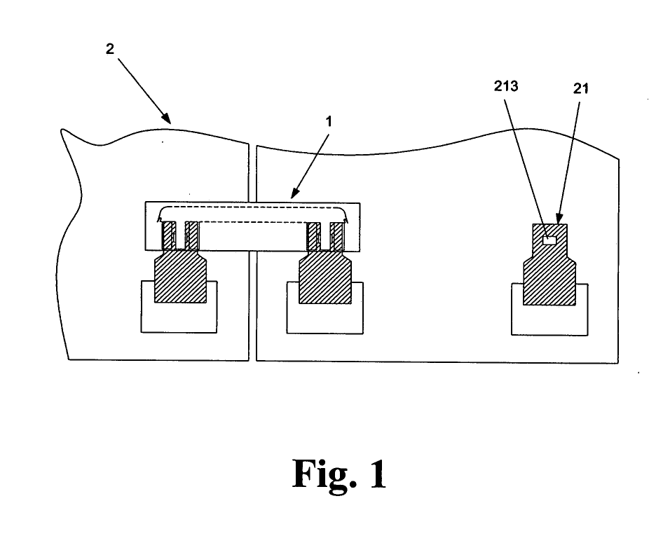

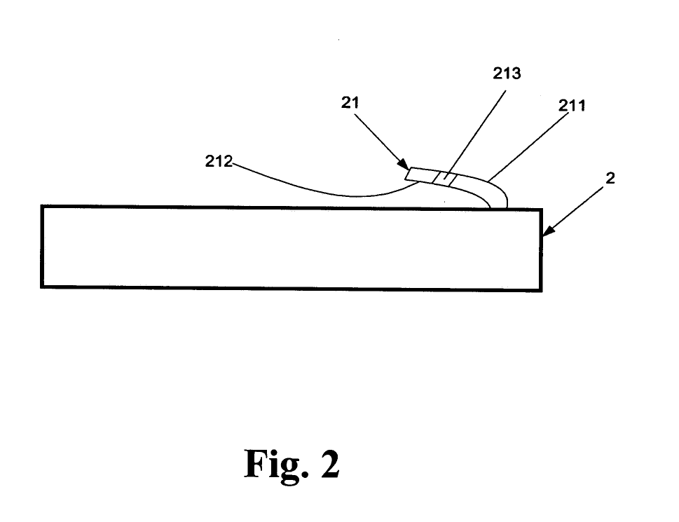

Referring to FIG. 1, two batteries of a UPS are connected in series by using the battery terminal connector to conduct two terminals 21 on different batteries. As shown in FIG. 2, the terminals 21 of the batteries are bended metal sheets with through holes 213 formed thereon.

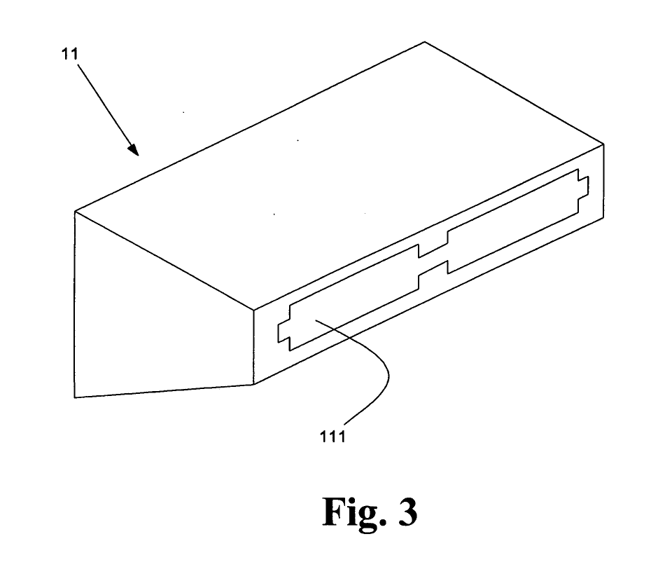

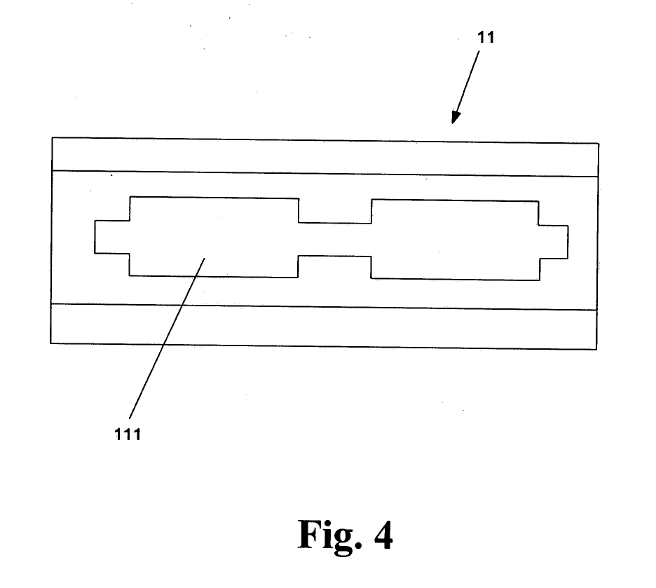

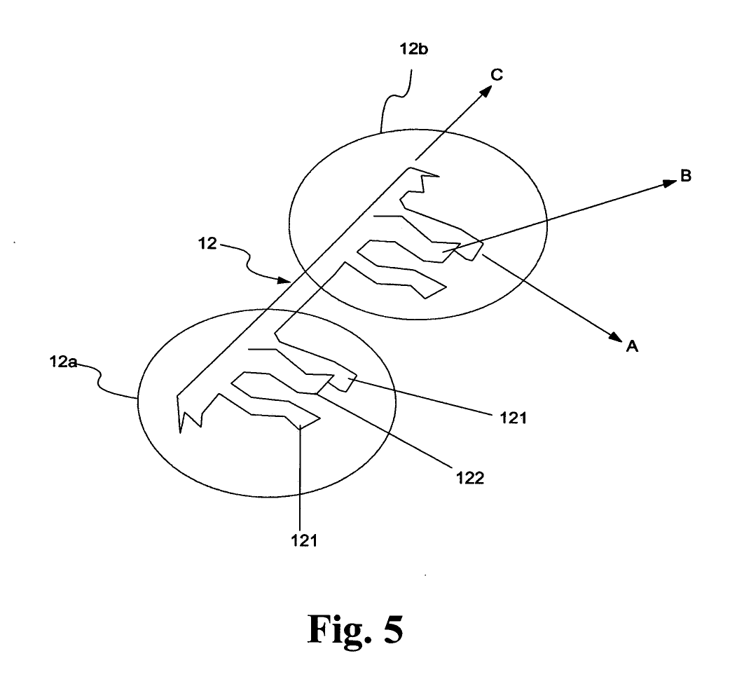

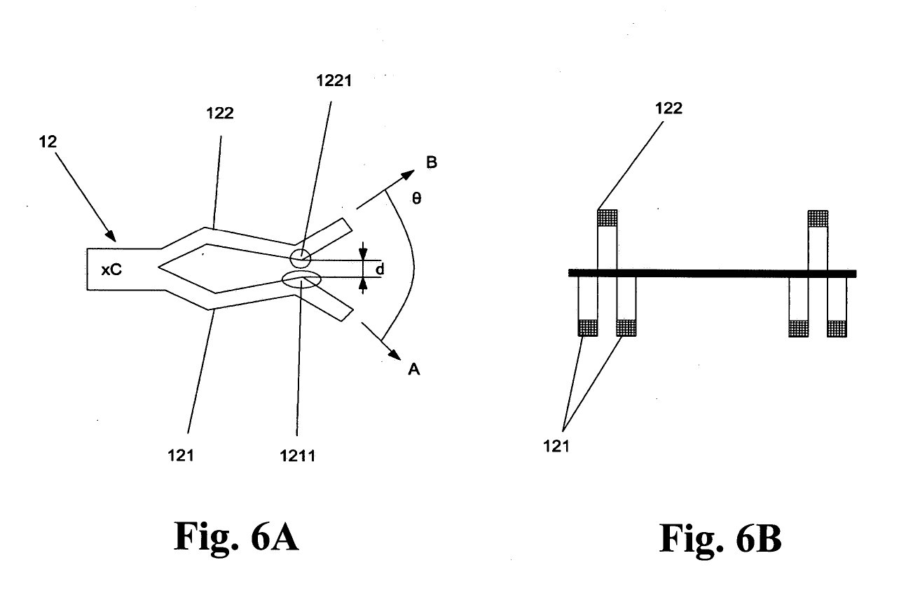

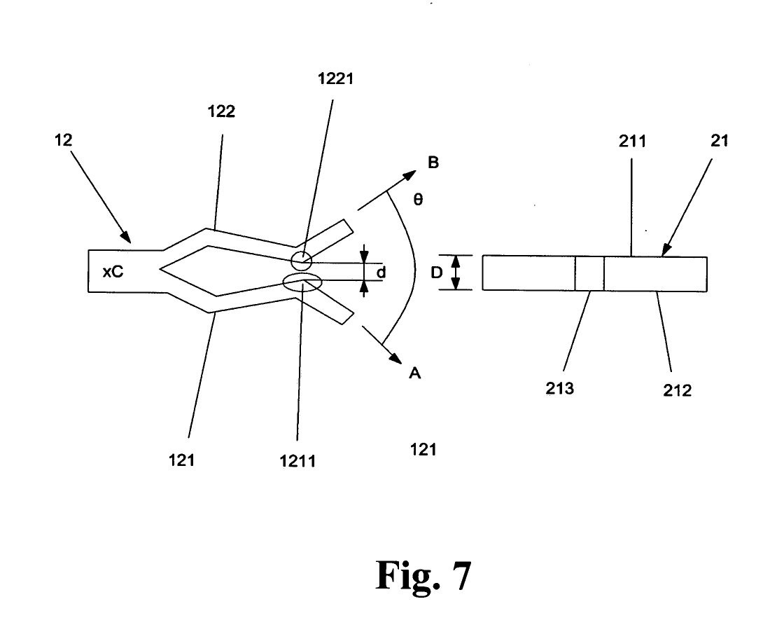

Referring to FIGS. 3, 4, 5, 6A, 6B and 7, the illustrating views show that the battery terminal connector 1 includes an electrically insulating element 11 and a conductive element 12. The electrically insulating element 11 has a slot 111 for accommodating the conductive element 12 which has two apart arranged terminal connecting parts 12a and 12b extending there-from. The structure of the electrically insulating element 11 is shown in FIGS. 3 and 4, and the structure of the conductive element 12 is shown in FIG. 5, FIG. 6A, and FIG. 6B.

As shown in FIGS. 5, 6A, 6B and 7, each terminal connecting part 12a or 12b on the conductive element 12 is composed of two wavelike fins 121 leading the orientation of the open ends towards direction A and one wavelike fin 122 leading the orientation of the open end towards direction B. These wavelike fins 121 and 122 are the same in shape and are arranged adjacent to each other with the wavelike fin 122 being between the wavelike fins 121. The included angle Θ between the direction A and direction B is predetermined when forming the conductive element 12 and has magnitude between 0 and 90 degrees. In addition, either direction A or B is perpendicular to the longitudinal direction C of the conductive element 12. Besides, the open end of the wavelike fins 122 of the terminal connecting parts 12a and 12b have the same orientation leading direction B.

On the other hand, each of the wavelike fins 121 or 122 is formed with curved portion 1211 or 1221 for each terminal connecting part 12a or 12b, and the convex tips of these curved portions 1211 and 1221 define a space there-between with the convex tips of two curved portions 1211 being in the same plane. Also, the vertical distance of the space d is smaller than the thickness of the battery terminals 21 to which the battery terminal connector is connected.

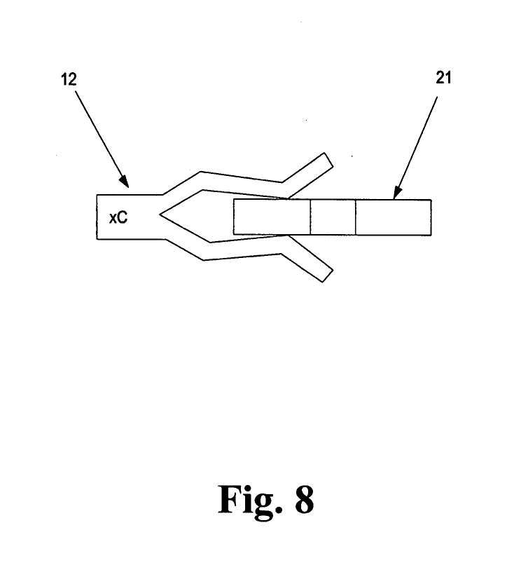

Referring to FIG. 8, when the battery terminal connector is used to connect with two batteries in series, the terminal connecting part 12a and 12b are respectively connected to terminals 21 of different batteries. Accordingly, the curved portions 1211 of two wavelike fins 121 of the terminal connecting part 12a are in contact with the lower surface 212 of the first battery terminals 21 while the curved portion 1221 of the wavelike fin 122 of the terminal connecting part 12a is in contact with the upper surface 211 of the first battery terminals 21; and, the curved portions 1211 of two wavelike fins 121 of the terminal connecting part 12b are in contact with the lower surface 212 of the second battery terminals 21 while the curved portion 1221 of the wavelike fin 122 of the terminal connecting part 12b is in contact with the upper surface 211 of the second battery terminals 21. Thereby, the first and second battery terminals 21 are respectively buckled between the wavelike fins 121 and 122 for each terminal connecting part 12a or 12b.

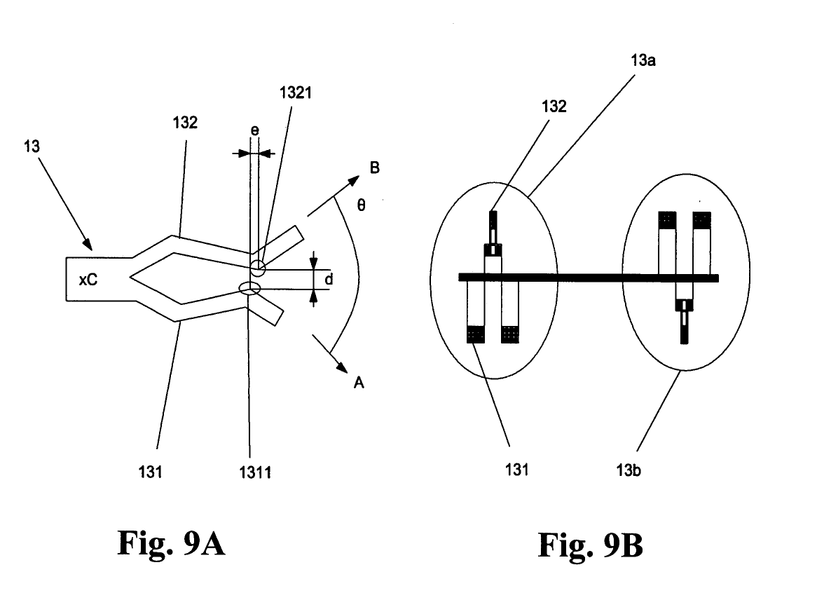

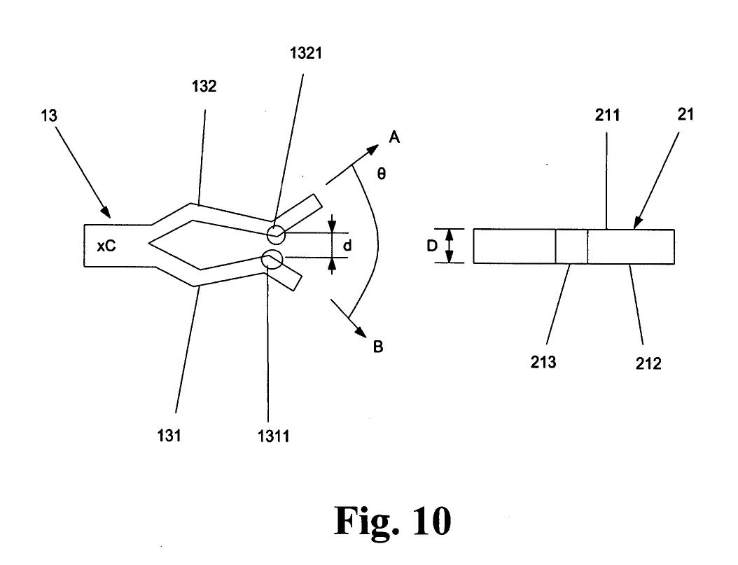

Referring to FIGS. 9A, 9B and 10, the above mentioned conductive element 12 according to another embodiment of the present invention is replaced by the following described conductive element 13.

The conductive element 13 has two apart arranged terminal connecting parts 13a and 13b extending there-from. Each terminal connecting part 13a and 13b on the conductive element 13 is composed of two wavelike fins 131 the orientation of the open ends of which is direction A and one wavelike fin 132 the orientation of the open end of which is direction B. These wavelike fins 131 and 132 are the same in the shape and are arranged adjacent to each other with the wavelike fin 132 being between the wavelike fins 131. The included angle Θ between the direction A and direction B is predetermined when the conductive element 13 is formed and has a magnitude between 0 and 90 degrees. Also, either direction A or B is perpendicular to the longitudinal direction C of the conductive element 13.

Besides, an included angle between the orientation of the open end of the wavelike fins 132 of the terminal connecting part 13a and the orientation of the open end of the wavelike fins 132 of the terminal connecting part 13b is the same as the included angle Θ between the direction A and direction B. That is to say, the orientation of the open end of the wavelike fin 132 of the terminal connecting part 13a is the same as the direction B, and the orientation of the open end of the wavelike fin 132 of the terminal connecting part 13b is the same as the direction A.

On the other hand, each of the wavelike fins 131 or 132 is formed with curved portion 1311 and 1321 for each terminal connecting part 13a or 13b, and the convex tips of these curved portions 1321 and 1311 define a space there-between with the convex tips of two curved portions 1311 being in the same plane. Also, the vertical distance of the space d is smaller than the thickness of the battery terminals 21 to which the battery connector is connected.

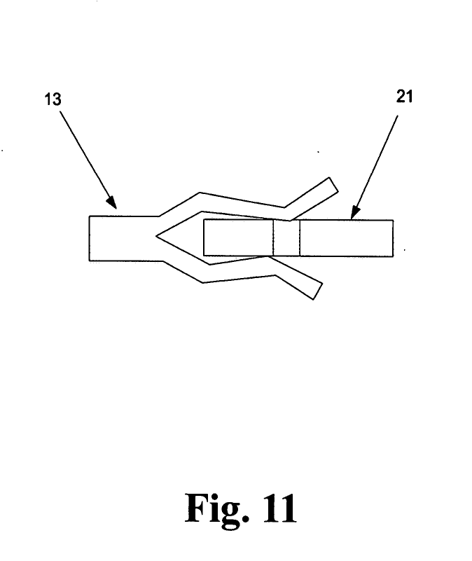

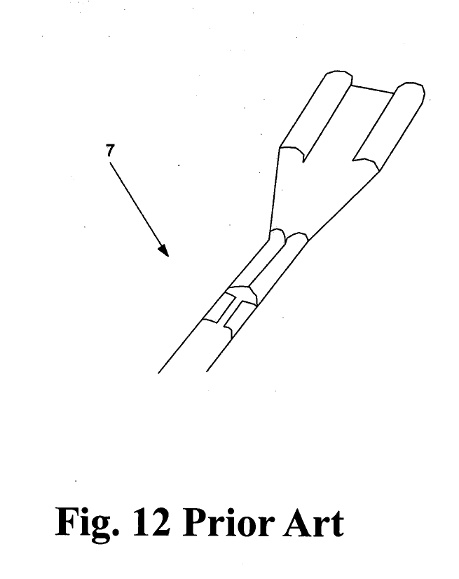

Also, the width of the curved portion 1321 is smaller than the width of the curved portion 1311, and there is misalignment e between the curved portion 1311 of the first wavelike fin (131) and the curved portion 1321 of the second wavelike fin 132, that is the curved portion 1311 is behind the curved portion 1321 as shown in FIGS. 9A and 10. Referring to FIG. 11, when the terminal connecting parts 13a and 13b of the conductive element 13 are respectively coupled with the battery terminals 21 of two batteries to be connected in series, the curved portions 1311 of two wavelike fins 131 of the terminal connecting part 13a are in contact with the lower surface 212 of the first battery terminals 21, and the curved portion 1321 of the wavelike fin 132 of the terminal connecting part 13a is trapped into the through hole 213 of the first battery terminals 21; while the curved portions 1311 of the wavelike fin 131 of the terminal connecting part 13b are in contact with the upper surface of the second battery terminals 21, and the curved portion 1321 of the wavelike fin 132 of the terminal connecting part 13b is trapped into the through hole 213 of the second battery terminals 2, thereby two battery terminals 21 are clamped.

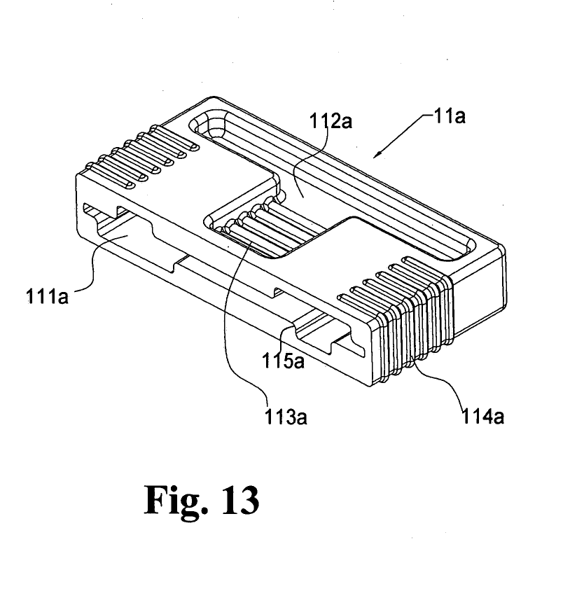

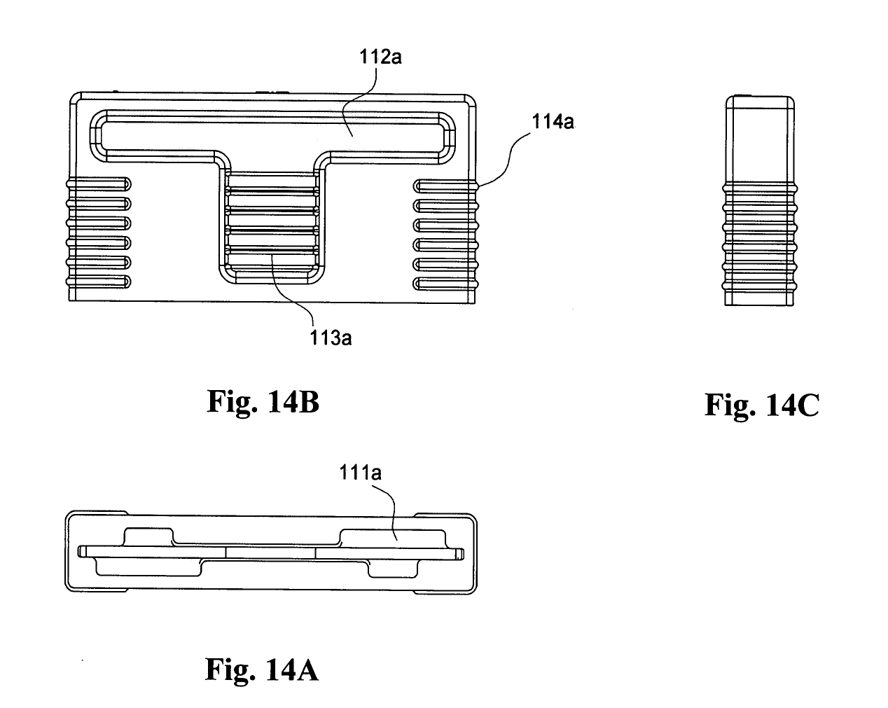

Referring to FIGS. 13, 14A, 14B and 14C, in another embodiment of the invention, the electrically insulating element 11a has a slot 111a for accommodating the conductive element 13. In addition, the upper surface of the electrically insulating element 11a is formed with a T-shaped recess 112a for diminishing the use of plastic material in processing, and there are a plurality of line-shaped ribs 113a formed on the recess 112a to compensate the strength insufficiency due to the less use of the plastic material. On the other hand, there are a plurality of [symbol] -shaped ribs 114a formed to surround the upper surface of the electrically insulating element 11a, the side surfaces adjacent to the upper surface, the lower surface opposite to the upper surface for reinforcing the structure strength. Also, the edge of the mold of the electrically insulating element 11a is applied with fillet curve design for avoiding stress concentration caused on the electrically insulating element 11a during the demolding process of the electrically insulating element 11a; therefore, any intersection part between surfaces inside the slot 111a is formed to be fillet curve 115a.

Furthermore, the slot 11a can be designed to have a first division for accommodating the terminal connecting part 13a and a second division for accommodating the terminal connecting part 13b, wherein the cross-section profile of the second division is reversely the same as that of the first division.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A battery terminal connector, comprising:
an electrically conductive element having a first terminal connecting part and a second terminal connecting part being apart, each terminal connecting part comprising three adjacent wavelike fins each of which being formed with at least one curved portion, there being a predetermined angle between the orientation of the open end of the middle wavelike fin and the orientation of the open ends of other wavelike fins for each terminal connecting part; and
an electrically insulating element formed with a slot for accommodating the electrically conductive element;
wherein there is a space between the curved portions of the wavelike fins for each terminal connecting part with the vertical distance of the space being smaller than the thickness of a battery terminal to which the battery terminal connector is connected.

2. The battery terminal connector as set forth in claim 1, wherein an included angle between the orientation of the open end of the middle wavelike fin of the first terminal connecting part and the orientation of the open end of the middle wavelike fin of the second terminal connecting part is the same as the predetermined angle.

3. The battery terminal connector as set forth in claim 2, wherein the width of the curved portion of the middle wavelike fin is smaller than the width of the curved portions of other wavelike fins for each terminal connecting part.

4. An electrically conductive element for battery terminal connector, comprising:
a first terminal connecting part and a second terminal connecting part being apart, each terminal connecting part comprising three adjacent wavelike fins each of which being formed with at least one curved portion, there being a predetermined angle between the orientation of the open end of the middle wavelike fin and the orientation of the open end of other wavelike fins for each terminal connecting part;
wherein there is a space between the curved portions of the wavelike fins for each terminal connecting part with the vertical distance of the space being smaller than the thickness of a battery terminal to which the battery terminal connector is connected.

5. The electrically conductive element for battery terminal connector as set forth in claim 4, wherein an included angle between the orientation of the open end of the middle wavelike fin of the first terminal connecting part and the orientation of the open end of the middle wavelike fin of the second terminal connecting part is the same as the predetermined angle.

6. The electrically conductive element for battery terminal connector as set forth in claim 5, wherein the width of the curved portion of the middle wavelike fin is smaller than the width of the curved portion of other wavelike fins for each terminal connecting part.

7. An electrically insulating element for battery terminal connector, comprising:
a slot for accommodating a conductive element;
a T-shaped recess formed on a first surface of the electrically insulating element;
a plurality of first ribs formed to surround the first surface, a second surface adjacent to the first surface, and a third surface opposite to the first surface and adjacent to the second surface;
a plurality of second ribs formed to surround the first surface, the third surface, and a fourth surface adjacent to the first surface and opposite to the second surface; and
a plurality of third ribs formed on the T-shaped recess;
wherein any intersection part between surfaces inside the slot is formed to be fillet curve.

8. The electrically insulating element for battery terminal connector as set forth in claim 7, wherein the first ribs and the second ribs are [symbol] -shaped.

9. The electrically insulating element for battery terminal connector as set forth in claim 7, wherein the third ribs are line-shaped.

10. The electrically insulating element for battery terminal connector as set forth in claim 7, wherein the conductive element includes a first terminal connecting part and a second terminal connecting part, the slot comprises a first division for accommodating the first terminal connecting part and a second division for accommodating the second terminal connecting part, the cross-section profile of the second division is reversely the same as that of the first division.
